(19) United States
(12) Patent Application Publication
(10) Pub. No.: US 2006/0149564 A1
(43) Pub. Date: Jul. 6, 2006

(54) System and Method of Doing Business for Multi-Vendor Network Infrastructure Solutions, Training, and Research and Development

(75) Inventor: Antonio Davis, Olathe, KS (US)

Correspondence Address: Antonio Davis, 14460 W. 121st Terrace, Olathe, KS, 66062, US

(73) Assignee: Mr. Antonio Davis, Olathe, KS (US)

(21) Appl. No.: 10/905,422

(22) Filed: Jan. 3, 2005

(51) Int. Cl. G06Q 99/00; G06F 9/44; G06F 17/50

(52) U.S. Cl. 705/1; 705/7

(57) ABSTRACT

Virtual Innovator is a Solutions/Training/R&D Multi-Vendor Laboratory, built for the customers of the Information and Communications Technology industry. A customer can come to Virtual Innovator for Solutions, Training, or R&D for their single or multi-vendor network infrastructures. At Virtual Innovator a customer can resolve the simplest or most complex network issues. Customers also have the opportunity to receive detailed, in-depth training on any hardware/software device of their choice, along with the option of test driving the latest innovations of hardware/software vendors worldwide, for R&D purposes. Customers will be afforded access to Virtual Innovator via the internet or on-site.

The System and Method of Doing Business for Multi-Vendor Infrastructure Solutions, Training, and Research and Development is a business process detailing the operations of a company named Virtual Innovator.

Virtual Innovator is a Solutions/Training/R&D Multi-Vendor Laboratory, built for the customers of the Information and Communications Technology industry. A customer can come to Virtual Innovator for Solutions, Training, or R&D for their single or multi-vendor network infrastructures. At Virtual Innovator a customer can resolve the simplest or most complex network issues. Customers also have the opportunity to receive detailed, in-depth training on any hardware/software device of their choice, along with the option of test driving the latest innovations of hardware/software vendors worldwide, for R&D purposes. Customers will be afforded access to Virtual Innovator via the internet or on-site.

What is claimed is:

1. “What I claim as my invention is a business process detailing the operations of a company named Virtual Innovator, which I own. Virtual Innovator is a Solutions/Training/R&D Multi-Vendor Laboratory, built for the customers of the Information and Communications Technology industry. A customer can come to Virtual Innovator for Solutions, Training, or R&D for their single or multi-vendor network infrastructures. At Virtual Innovator a customer can resolve the simplest or most complex network issues. Customers also have the opportunity to receive detailed, in-depth training on any hardware/software device of their choice, along with the option of test driving the latest innovations of hardware/software vendors worldwide, for R&D purposes. Customers will be afforded access to Virtual Innovator via the internet or on-site”
